(19) United States
(12) Patent Application Publication
(10) Pub. No.: US 2004/0111334 A1
(43) Pub. Date: Jun. 10, 2004

(54) Method of interactive home detail submission and pricing

(76) Inventor: Robert John Clifford Parsons, Oakville (CA)

Correspondence Address: VENABLE, BAETJER, HOWARD AND CIVILETTI, LLP, P.O. BOX 34385, WASHINGTON, DC, 20043-9998, US

(21) Appl. No.: 10/315,009

(22) Filed: Dec. 10, 2002

(51) Int. Cl. G06F 17/60

(52) U.S. Cl. 705/27

(57) ABSTRACT

A method of specifying a home through an interactive computer device communication which establishes, a home selection program, a database including details of geographical locations, pictorial views of home designs available, home details available for such homes, and pricing information of such designs and details. The purchaser at a second device is able to access the home design program modify floor plans of a selected home design to suit his requirements, and select specific details of a home design, by selecting from a group of pictorially represented variables in said first device. The first device calculates an adjusted price based on selections made by the purchaser and transmits the adjusted price to the purchaser. The purchaser can then submit his completed purchase order for approval.

### FIELD OF THE INVENTION

The invention relates to a method for interactive selection, via the internet and a personal computer, by a prospective purchaser, of a new home, and details of construction and decor of the home, and to determining pricing. This invention further relates to a method, system and computer product for Internet ordering of a custom home.

### BACKGROUND OF THE INVENTION

The erection of a new home by a purchaser usually starts with the purchaser selecting, and purchasing a lot in a specific location. The specifying of a new home to be erected at that location by the purchaser can then be a lengthy process. Numerous model homes may be viewed. Numerous variations in floor area, interior and exterior finish, decor, colour selection, and so on, may all enter into the final choice. Price is always a factor to be weighed against the value of any of these selections. In most cases the customer must visit a site where model homes are on display. The expense of erecting model homes, of various different designs, is a major cost for the builder. In addition, the builder must pay staff at those model home sites, who are available to show customers the model homes, and discuss selection of models, as well as features and changes.

Where the location is a major sub division this cost may become reduced as the sub division is built, since the various model homes available will gradually be built as actual homes. These actual homes can usually be viewed by prospective buyers so that the need for maintaining model homes becomes less, as time goes on.

However in the case of the sale of vacation homes or a single home for a subdivision, there is no such possibility.

Each home purchased will usually be built individually at a location, perhaps in vacation country or in a subdivision lot.

This lot location may be at a great distance from the prospective purchaser of a new home. He will not be able to see the variety of homes available without travelling great distances at considerable inconvenience. Thus in-the case of vacation homes the builder has no choice but to erect and maintain a selection of his vacation homes, fully erected and staffed by sales personnel. The location of these model homes, usually in so-called “sales courts”, will preferably be close to urban areas where the purchasers may live and work. These sales courts, and the cost of providing sales staff, add greatly to the cost of selling these vacation homes. This cost must be factored in to the end price of the home, thus increasing the price to the purchaser.

In addition the purchaser is usually obliged to spend much time visiting a sales court and discussing features of the various model homes, and floor plans. He will want to know the cost of changing the floor plan, or the actual floor area, or other features, and the effect on the end price. The prospect may in fact wish to visit several sales courts of several different builders, to make comparisons of various homes available from various builders and home designers.

This whole process can take many weeks or months. During all this time the builders of the homes are incurring expenses both for sales staff and for land costs, utilities, taxes, and other expenses all of which must be incurred to be able to present the prospects with the information they need in order to make a final decision.

Buyers also generally desire multiple visits to consider and reconsider their selections of various details of construction and design, before making their final order. This compounds the costs of maintaining and staffing the model homes.

In addition the purchaser must spend a great deal of time travelling from one sales court to another. He may be unable or unwilling to travel to the sales courts of some builders or home designers due to the time and delay involved. Even when he does arrive at the sales court there may be a lengthy wait while other customers are being shown around, before he can start his selection process. This may mean that some builders are never in the mind of the prospective purchaser at all, because he can never find the time to visit them all. From the view point of the purchaser, these delays may cause him frustration and he may possibly make a hasty decision based on inadequate knowledge, in order to simply advance his project.

Clearly the cost of the home could be substantially reduced if the selection process could be made available at a network connected device of a purchaser, whether a personal computer, WAP device or other similar device, over the internet, without the need for sales personnel to assist in the process. Sales courts would no longer be required. Staff could be reduced. Comparison shopping could be expedited. A builder could provide all this information, and the facility for making changes and selections, on a web server, and be sure his business, and model homes, were always available for inspection by purchasers. The purchaser could make such inspection, from his personal computer over the Internet, at his convenience at any time of the day or night on any day. Many people could access the web server program simultaneously, thus avoiding waiting in line to speak to a salesperson.

The purchaser would have all the information at his fingertips, and the pricing could be made available automatically. He could then see immediately the end cost of his prospective home, and the cost increment of any special selections he had made.

Preferably all the information of a particular purchaser would be stored in a purchasers file in the host computer, and secured with a password for that purchaser. The purchaser would then have his file available so that he could print out details of his proposed home. He could then discuss these with his family, financial advisors and others, and obtain their advice, before making a commitment to buy. If desired he could then re- access his file and make further adjustments to meet the needs of others, and then immediately see the new price resulting from the changes.

Another factor which can affect price, details of which may not be known to the purchaser, result from the proposed location of the home. This may affect simply the cost of shipping. More importantly however it may affect such things as sales taxes, local by- laws, and building codes and restrictions, and the like. Normally this information will not be available at, for example, a sales court. It may have a significant effect on the end price. It may also require major changes in construction. It may in some cases simply make it impossible for the purchaser to erect the home of his choice, in the selected location.

Preferably these factors will be available on the home selection system, in the host computer, and the purchaser will be advised of them from the beginning of his selection process.

### BRIEF SUMMARY OF THE INVENTION

The invention relates to a method for interactive selection via the Internet and a network connected computer device, by a prospective purchaser, of a new home, and details of construction and decor of the home, and to determining pricing. In particular the purchaser can specify a location for the proposed home, and can view a selection of new home designs, suitable for that location. The new home designs are, stored in a host computer, and allow the purchaser to view a selection of various construction plans, details, finishes, decor, decks, railings and the like. Using a network connected computer device the purchaser can then select those features and choices that he desires, can change floor plans, alter floor area, can select the colour of various finishes. In addition the program will automatically show the cost of each selection, and will adjust the end price of the home.

With a view to providing a system which achieves the foregoing objectives the invention provides a method of specifying a home through interactive computer communication and comprising the steps of, establishing, in a host computer device, a home selection program, establishing, in a storage device, a database including details of geographical locations, pictorial views of home designs available, pictorial representations of floor plans of such homes, home details available for such homes, and pricing information of such designs, floor plans and details, enabling a purchaser at a remote computer device to access the program in the host computer device, the program requesting from the purchaser file set-up information from the purchaser including the location of the proposed home, enabling the purchaser through the remote computer device to access data at the host computer device corresponding to the set-up information and thereafter to view pictorial home designs available for the corresponding data and to select a design of his choosing, and transmit his selection to the host computer device, enabling the purchaser through the remote computer device to view pictorial representations of floor plans for such home designs at the host computer device, and to select a floor plan for a the selected home design and to modify the selected floor plan of such selected home design to suit his requirements, at the host computer device calculating an adjusted price for the modified home design and transmitting same to the remote computer device to the purchaser, enabling the purchaser through the remote computer device to select specific details of the home design, by selecting from a group of pictorially represented details in the host computer device, and the host computer device calculating an adjusted price based on selections made by the purchaser and transmitting the adjusted price to the remote computer device to the purchaser, and, establishing data storage accessible through the host computer device and remote computer device to the purchaser for enabling the purchaser to save information comprising a home location, a home design, a home floor plan and home details selected by a purchaser and the adjusted price supplied by the host computer device.

The various features of novelty which characterize the invention are pointed out with more particularity in the claims annexed to and forming a part of this disclosure. For a better understanding of the invention, its operating advantages and specific objects attained by its use, reference should be made to the accompanying drawings and descriptive matter in which there are illustrated and described preferred embodiments of the invention.

### IN THE DRAWINGS

FIG. 1 a schematic perspective of the general arrangement of devices for the practice the method illustrating the invention;

FIG. 2 illustrates the main resources of the system of the present invention;

FIG. 3 illustrates the resources of the web server application of the present invention;

FIG. 4a is a flow chart of the main steps of the interactive home selection soft ware ;

FIG. 4b is a flow chart illustrating further steps of the interactive home selection software; and

FIG. 5 further illustrates the resources of the computer product of the present invention, and the related user input.

### DESCRIPTION OF A SPECIFIC EMBODIMENT

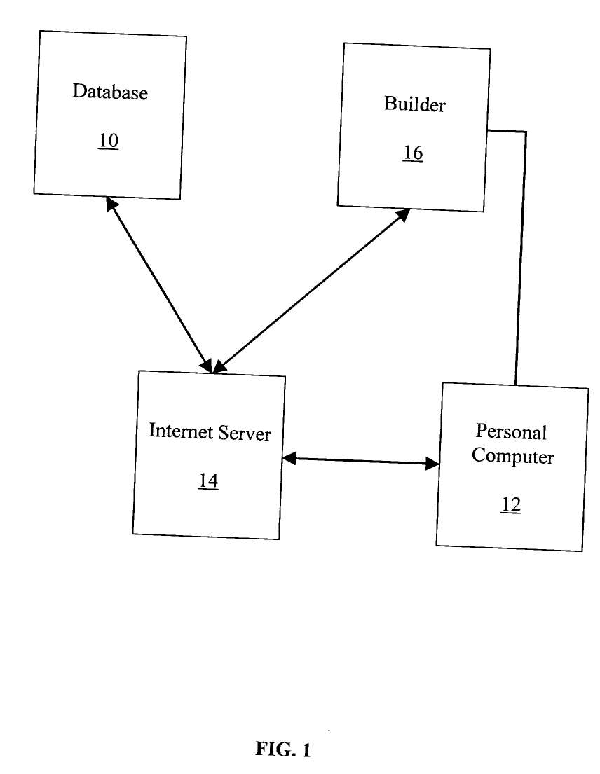

The method illustrative of this embodiment of the invention is shown as being practised using a general arrangement of facilities as illustrated schematically in FIG. 1. FIG. 1 illustrates a general database (10) connected to an internet server(14) which is connected to the builder(16) and the purchaser's personal computer(12). The purchaser connects to the database(10) through the internet server(14) and accesses the website data stored on the database(10). The internet server(14) contacts the builder(16) with information submitted by the user through the personal computer(12). The builder(16) may then contact the user through the user's personal computer(12).

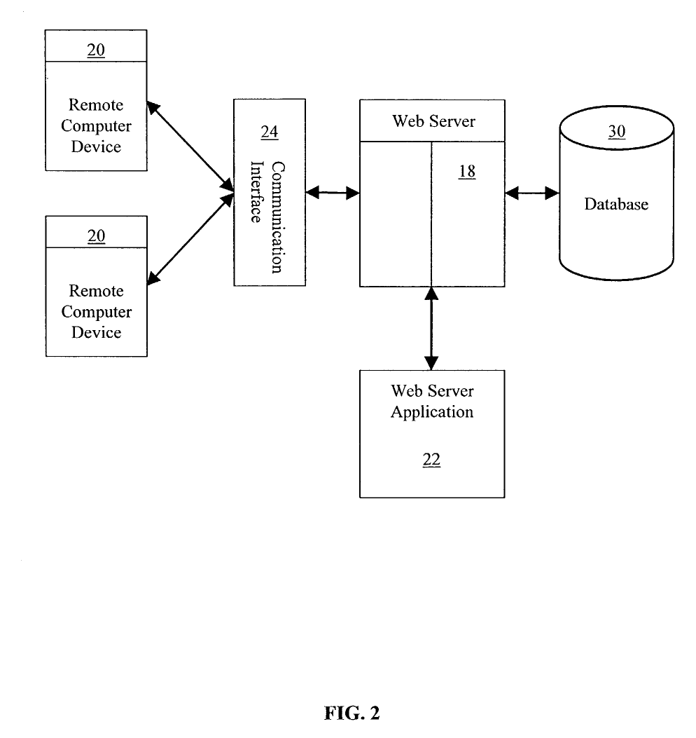

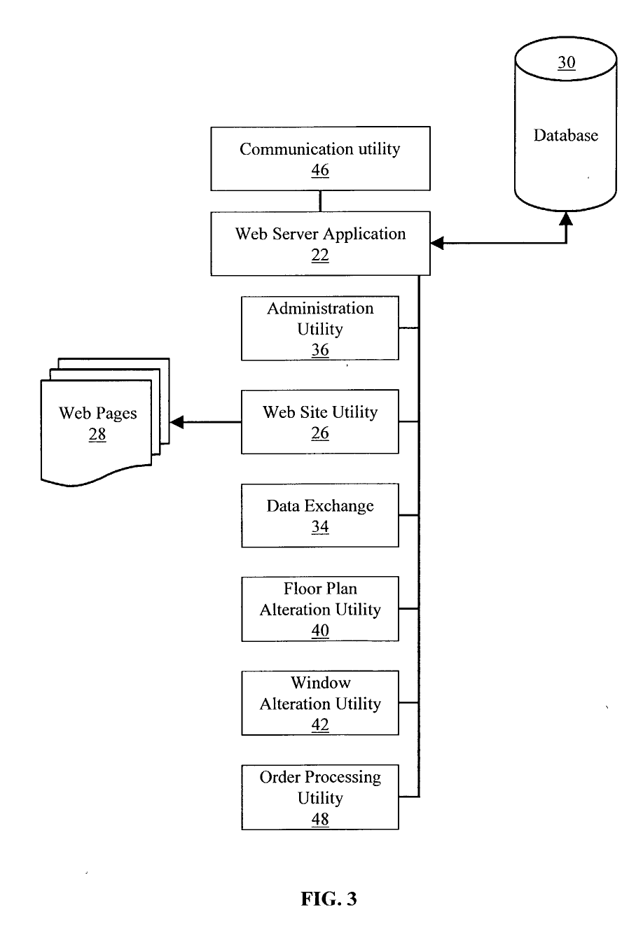

FIG. 2 illustrates the main components of the system of the present invention. As shown in FIG. 2, a host computer device generally represents a known web server(18) commonly used for providing and making available a web site consisting of a software program, for access by any one of a number of remote network connected computer devices or remote computer devices shown generally as (20). The host computer device may also include active directory servers, database servers (e.g. an SQL server), communication servers and exchange servers, configured in a manner that is known. The host computer device may include a number of known hardware and software utilities for providing access to the resources described herein. In one particular illustrative embodiment of the present invention, the host computer device consists of known hardware and software utilities for providing Internet provisioning in accordance with the Application Service Provider (“ASP) model. In particular, and as shown in FIG. 3, the host computer device includes a web server application(22), provided in a manner that is known, for providing access at one or more of the remote computer devices(20) to the utilities described herein.

As best illustrated in FIG. 2, the remote computer devices may consist of any manner of known device including a microprocessor, memory and communication interface(24) for sending and receiving communications over a computer network such as the Internet. These devices may include a personal computer, WAP device or other similar device. In the case of a personal computer, this device may be in for example a public library, a commercial establishment such as a print shop, or a cafe, or possibly in the offices of a home designer, or even a real estate sales agency, but in most cases they represent personal computers available in a home.

The web server(18) includes a known web site utility(26) for making available via the Internet a series of web pages(28) included in the web site. The web server(18) is functionally linked with a database(30) in a manner that is known, such that the web site utility(26) populates the described web pages(28), in accordance with predetermined formats, with data provided to the database(30) from time to time. The web pages(28) include web pages consisting of home designs, floor plans, design and decor details of such homes, pricing detail related to the foregoing and other related information. The web site utility(26) is therefore adapted to keep the web pages(28) up to date by loading data on the database(30) using a known database utility(32).

One of more of the web pages(28) provided by the web site utility(26) include fields for receiving input from users of the remote devices(20), in a manner that is known. The users may select and deselect home designs, floor plans, design and décor details, and other related information displayed (hereafter referred to as “Home Attributes”)(38) in the web pages(28) by selecting items from drop down menus, inputting selection to web forms, clicking on selected items and the like, in a manner that is also known.

The web server application(22) includes a data exchange(34) for processing data received via the web pages(28) in accordance with a plurality of routines described herein. These routines are part of programming for the utilities or resources described herein, provided in a manner that is known.

The web server application(22), as shown in FIG. 3, includes a known administration utility(36). The web site utility(26) provides a web page(28) requesting data required to create a user profile for accessing the functions of the host device. The user profile may include a username, password, and other data. Upon provision of the required information, the administration utility(36) creates the user profile in the database(30) in a manner that is known. The administration utility(36) restricts access to the functions of the web pages(28) described herein to users having provided a recognized username and password, in a manner that is known.

In one aspect of the present invention, a user can make various selections related to particular Home Attributes(38) in one Internet session. These selections are stored in the database(30) in association with the user's user profile in a manner that is known. In subsequent Internet sessions, upon logging into the web site(28), the user can retrieve his/her selections, show them to another person, and make changes if required.

The web pages(28) indicate the various prices related to selections of particular Home Attributes(38). The data exchange(34) includes a known routine for dynamically calculating the total price of a home selected via the web pages(28), including the price of the various items comprising the Home Attributes(38). The web site utility(26) displays this total price to appropriate web pages(28). Price being an important aspect of a user's decision-making process in selecting a home, this allows the user to dynamically select and deselect Home Attributes(38) including based on their impact on the total price displayed.

Another aspect of the invention is a floor plan alteration utility(40) included in the web server application(22). The floor plan alteration utility(40) permits users to alter the floor plan(22) of a house, including decks that are often attached to a house, interior and exterior walls, and window locations, for example. The web site utility(26) displays walls comprising a floor plan as a series of web objects in the web pages(28), in a manner that is known. The web site utility(26) highlights the walls comprising a floor plan that a user can move by means of the floor plan alteration utility(40), and those that cannot be moved (because they are load bearing, or some other reason). The walls that are permitted to be moved, can be dragged and moved within predetermined ranges, in a manner that is known. The resulting input by the user is received by the data exchange(34) that results in an adjustment to the total price, as outlined above.

Another aspect of the present invention is a window alteration utility(42) whereby windows included in template home designs and/or floor plans displayed via the web pages(28) can be moved, changed for different windows, or within acceptable parameters all together new windows can be included in particular home designs and floor plans. As in the case of the floor plan alteration utility(40), the windows are displayed in the web pages(28) as a series of objects. The windows that may be moved are highlighted by the web site utility(26). The areas of the walls that can either receive a moved window, or a new window, are also highlighted by the web site utility. Based on parameters provided to the web site utility(26) as to permitted changes having regard to structural integrity and other factors, the user can click and place windows, or click and drag windows in a manner that is known. The resulting input by the user is also received by the data exchange(34) that results in an adjustment to the total price, as outlined above.

The functions described above permit a user to customise a home within established parameters. Another feature of the web site described, is that if a user wishes to customise a home in a way that falls outside of the established parameters, this may be achieved by engaging via the appropriate web page a “PROFESSIONAL ASSISTANCE”(44) or equivalent button that permits an email request to be routed via the communication utility(46) to service personnel of the operator of the web site.

Once the user has finalised its custom order for a home using the tools described above, the order is placed by consenting to a click-acceptance agreement provided in a manner that is known. The web server application(22) also includes an order processing utility(48) that includes a number of routines related to the processing of final orders placed by users via the web site. For example, the order processing utility(48) stores to the database a record containing the details of the a particular final order of a user. Upon receipt of an order, the order processing utility also sends one or more messages to personnel of the operator of the web site, as required for fulfilment of the order, in accordance with established business rules, in a manner that is known.

In accordance with the method of the present invention, the use of the web site to place an order for a house permits significant cost savings in that, as explained above, there is no longer a need for model homes, and an on-site sales force to process orders for homes. One aspect of the method of the present invention, is to offer a discount on the price of a home, in exchange for placing an order for a home via the web site.

The system of the present invention is best understood from FIG. 2 as the host computer of the present invention, functionally linked to the web server application(22). The system of the present invention, is also understood as the host computer, functionally linked to the web server application(22), and one or more remote devices(20), each associated with a user, for providing Internet based house selection.

The computer product of the present invention is best understood as the web server application(22), configured to cause a web server(18) to provide Internet based house selection on a remote computer device.

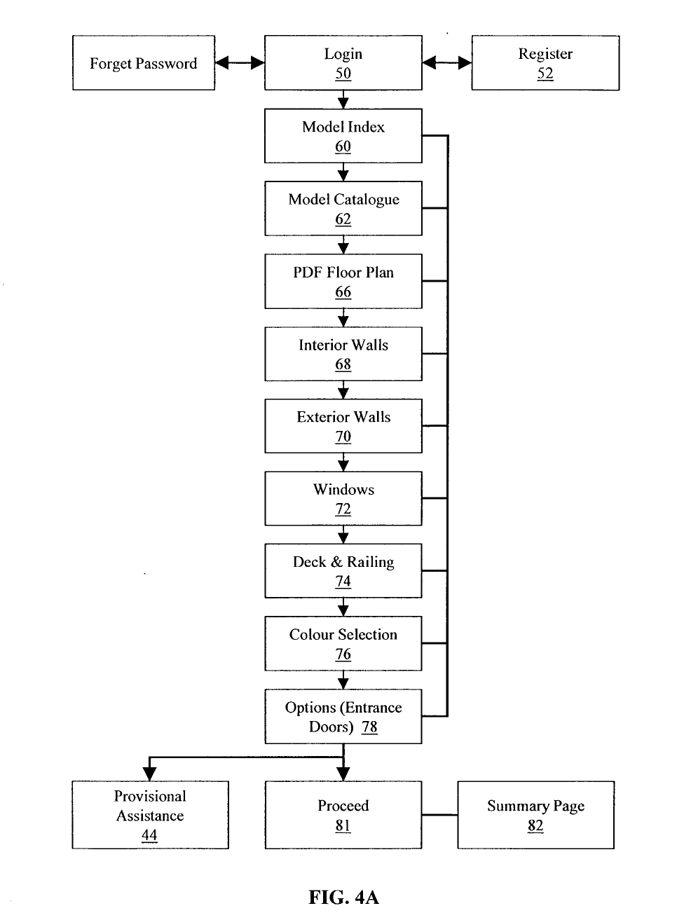

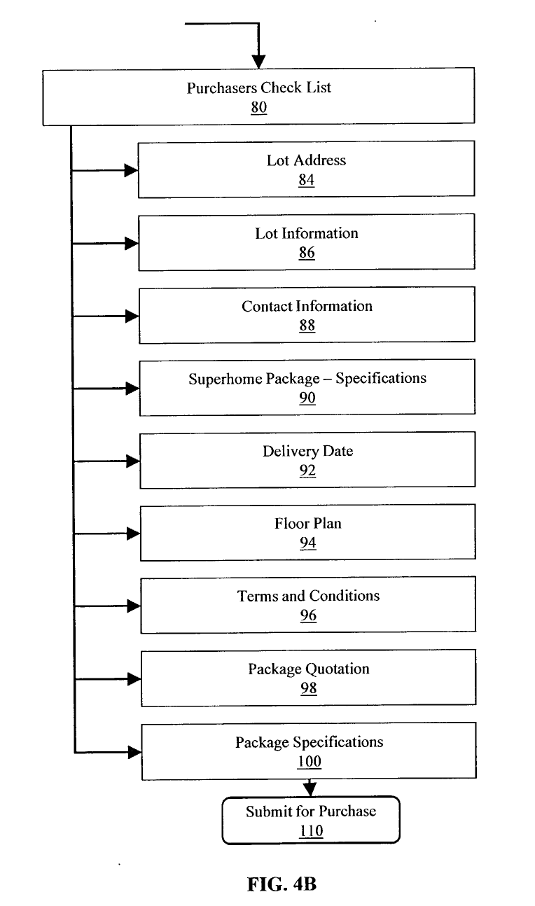

The present invention is illustrated by an example of the method in operation. Referring to FIGS. 4a and 4b it will be seen that this represents in block diagrammatic form the series of steps to be performed by a prospective purchaser. The example in operation below presents a series of steps representative of the method of the present invention. The method of the present invention does not require each such representative step.

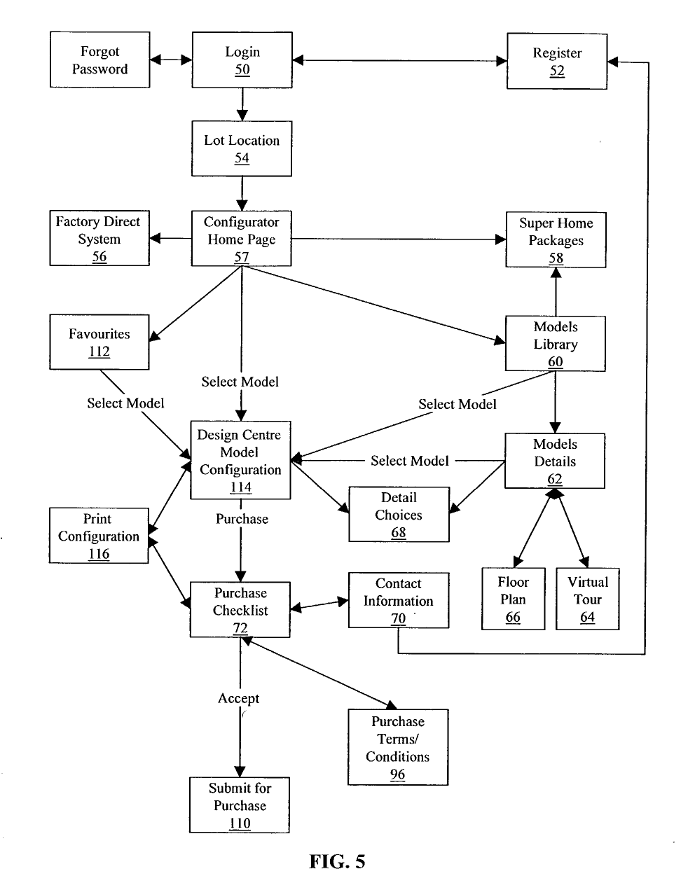

FIG. 5 illustrates the resources of the web site of the present invention, and the related steps involved in a user utilizing these resources.

While one embodiment of the present invention requires the user to login(50) to gain access to the features of the web site. Another embodiment may be made available where the user is able to access certain data and features of the web site without having to login. According to this embodiment of the present invention, the user is required to login at 50 and to enter his name and address and contact details such as phone number, email address and the like, as at registration(52). The user is then requested to select a password or code. The user decides on his password or code, then enters his password at the remote computer device(20) and sends it to the host computer device. The host computer checks the user's name and password to avoid duplication and then records it against the user's file. The user then exits and reenters the web site and “logs in” using the password submitted by him. The user may save any model selections and any modifications or details that he makes as favourites. The user may enter the saved files at any time to review of change details as he wishes.

Once logged into the program the user enters a lot location(54) in the web server application(22) or program as at from the remote computer device(20). The lot location data is sent to the host computer device where the program determines if the user should be directed to a factory direct system(56) or to a super home package(58). If a factory direct system(56) is available for the lot location(54), the user is directed to the factory rather than the computer program selection process.

If there is no factory direct system(56) available the user is directed to the super home package(58). At the super home package location the user may browse through a listing of available models in the model library(60). The particular super home packages available for a given lot location may vary with respect to the detail provided by the purchaser and by information stored on the database(30). Such information might include details about climate conditions, earthquake factors, local by -laws, building codes and any other aspect that may affect the type of structure permitted at a particular lot location. The models may be viewed pictorially in order of price or the overall area of the home. The user may view as many of the available models as he chooses.

The user may choose the model that interests him and view a more detailed description and pictorial layout of the home as in model details(62) provided to the database(30). The user is given the option to tour the model home plans virtually(64). The user may also view the floor plans(66) of the model homes.

The floor plans(66) of the model homes indicate interior walls(68) and exterior walls(70) that are moveable between a first position and a maximum second position. The user may adjust the location of the movable walls as he chooses by clicking on the chosen wall and dragging it to the new position. This is by operation of the floor plan alteration utility(40) described above. If the user relocates a moveable wall at the remote computer device(20), the program recalculates the price of the home by the change in square footage at the host computer device and displays the recalculated price immediately on the remote computer device(20). This is advantageous, since the user can make and remake the adjustments as he chooses and as he can afford, without involving sales personnel. The user then makes his selection and this is saved in the database(30).

Once the user has selected the model home that he wishes to modify, he is guided through a series of pictorial detail packages, containing detail choices(68) for windows, doors, siding colours, deck additions, roof shingles. At each selection of each detail the user will be prompted to accept the standard choice or to add to or change the selection. These changes will be made room by room for each selection. After each change at the remote computer device(20) the price of the model home will be again recalculated at the host computer device and displayed on the remote computer device(20).

After the user has made selections and modifications, he is given the option of proceeding with the sale as at or requesting that a professional sales assistant contact him as at. If the user chooses at the remote computer device(20) to be contacted by a professional sales assistant, the program at the host computer device provides a contact sheet(70) to be filled in by the user at the remote computer device(20). The contact sheet(70) is submitted by the remote computer device(20) to the host computer device and the sales assistant will contact the user shortly.

If the user chooses to proceed, the program at the host computer device reviews the contact information supplied at the registration of the process and determines if any information is missing. The host computer device then prompts the user to supply any missing information at the remote computer device(20).

The host computer device then produces a checklist(80) and displays it on the remote computer device(20) under summary page(82), prompting the user to review the purchase checklist(80). The checklist(80) outlines all of the information including lot location(84), lot information(86), contact information(88), home design(90), floor plan(94) and details of the model home and the changes implemented by the user. The user may make changes to the checklist from the checklist page(80). If the user wishes to make changes, he must from the remote computer device(20) choose the item on the checklist to change. The host computer device will then loop him back to the page containing those selections and display the selections on the remote computer device(20). The user then makes the changes on the remote computer device(20) and the host computer device again recalculates the price of the home and displays it on the remote computer device(20). Once the selection is accepted at the remote computer device(20), the host computer device redisplays the checklist(80) on the remote computer device(20). When the user is comfortable that the checklist is correct he chooses the proceed prompt.

The program requires the user to confirm information on a purchase agreement page(96) before the purchase agreement is submitted for processing. The user must confirm for example the lot location, contact information, the model home chosen and the floor plan with modifications and the home details. He must enter an approximate delivery date(92), confirm that he has read and agrees with the term and condition(96) of sale and the like.

When everything has been confirmed the user then submits(110) his request to the web server(18).

The model home and the modifications made by the user are reviewed by a sales assistant and approved for delivery if everything is acceptable. If there is some structural problem with the modifications the user will be contacted to discuss the problem. If the selections for the model home are acceptable, the order will be submitted for filling and the user will be contacted to arrange payment and delivery.

Throughout this program the user could suspend his selections at any time by saving his current selections under favourites(112). The user could then log out and proceed at another time that is convenient for him.

When the user logs back in, he will use his password and may either go to favourites(112) and continue modification or finalization of the purchase from the design center model configuration(114). The user may begin an entirely new selection process from the model library(60) if he wishes

The foregoing is a description of a preferred embodiment of the invention, which is given here by way of example only. The invention is not to be taken as limited to any of the specific features as described, but comprehends all such variations thereof as come within the scope of the appended claims.

What is claimed is:

1. A method of enabling interactive selection of a home by a user from a client computer via the Internet comprising the steps of:
providing access from the client computer to a home selection program located on a web server;
providing access to one or more web pages including a plurality of objects corresponding with design and structural features of homes including floor plan data and design feature data;
providing the price associated with the plurality of objects;
enabling the selection of the design and structural features of a selected home through a web interface, including the selection of a modified floor plan by enabling the user to input modified floor plan data through the web interface;
calculating the price associated with the selected design and structural features, and providing the calculated price to the user; and
enabling the user to place an order for a selected home acceptable to the user.

2. A method of enabling interactive selection of a home as claimed in claim 1, including the further steps of:
comparing the modified floor plan data to parameters defined by the home selection program to establish whether the modified floor plan data is authorized or unauthorized; and
accepting authorized modified floor plan data, and rejecting unauthorized floor plan data.

3. A method of enabling interactive selection of a home as claimed in claim 2, whereby the web server is functionally linked with a database such that the user is enabled to store selected design and structural features to the database in a first session, and retrieve/modify such design and structural features from the database in a second session.

4. A method of enabling interactive selection of a home as claimed in claim 3, whereby the home selection program enables the user to reset the selected design and structural features to a plurality of default design and structural feature settings.

5. A method of enabling interactive selection of a home as claimed in claim 4, including the further step of
requiring the user to submit location details of the proposed home, processing the location details, and providing objects corresponding to homes available for such location.

6. A method of enabling interactive selection of a home as claimed in claim 5, whereby the home selection program enables selection of design and structural features including roofing materials, siding materials, interior wall coverings, ceiling details, door details, deck details, railing details and window details.

7. A method of enabling interactive selection of a home as claimed in claim 6, whereby the home selection program enables selection of colours of selected home design details.

8. A method of enabling interactive selection of a home as claimed in claim 7, including the further step of providing to the client computer with a list of selected design and structural features, and requiring that the user verify each item on the checklist prior to processing the user's order.

9. A method of selecting a home at a client computer associated with a user, through the Internet, comprising the steps of
accessing a home selection program loaded on a web server using a browser loaded on the client computer;
accessing through the browser one or more web pages including a plurality of objects corresponding with design and structural features of homes including floor plan data and design feature data;
accessing the price associated with the plurality of objects from the web server;
entering into the client computer information describing selections of the design and structural features of a selected home, including the selection of a modified floor plan;
calculating at the web server the price associated with the selected design and structural features, and providing the calculated price to the user; and
placing an order for a selected home acceptable to the user.

10. A method of selecting a home from a client computer as claimed in claim 9, including the further step of offering a discount to the user for ordering the selected home through the Internet.

11. A method of selecting a home from a client computer as claimed in claim 10, including the further step of requesting registration information from the user to access one or more of the web pages.

12. A method of selecting a home from a client computer as claimed in claim 11, including the further step of enabling the userto store selected design and structural features to the database in a first session, and retrieve/modify such design and structural features from the database in a second session.

13. A method of selecting a home at a client computer as claimed in claim 12, including enabling the user to reset the selected design and structural features to a plurality of default design and structural feature settings.

14. A method of selecting a home at a client computer as claimed in claim 13, including the further step of requesting the user to submit location details of the proposed house, processing the location details, and providing objects corresponding to houses available for such location.

15. A method of selecting a home at a client computer as claimed in claim 14, further including the steps of selecting design and structural features including roofing materials, siding materials, interior wall coverings, ceiling details, door details, deck details, railing details and window details.

16. A method of selecting a home at a client computer as claimed in claim 15, further including the step of selecting colours of selected home design details.

17. A method of selecting a home at a client computer as claimed in claim 16, including the further step of providing the user with a list of selected design and structural features, and requiring that the user verify each item on the checklist prior to processing the user's order.

18. An interactive computer-implemented system for enabling the selection of a home by a user over the Internet at a client computer, comprising:
a server computer connected to the Internet for receiving information from the client computer describing the selected design and structural features of a home;
a home selection program in the server computer for:
processing the selected design and structural features so as to define the design and structural features of a selected home, including authorized modified floor plan data provided by the client computer;
calculating the price of a selected home; and
processing an order placed by the user of the client computer for a selected home acceptable to the user.

19. An interactive computer-implemented system as claimed in claim 17, further including the steps of
comparing the modified floor plan data to parameters defined by the home selection program to establish whether the modified floor plan data is authorized or unauthorized; and
accepting authorized modified floor plan data, and rejecting unauthorized floor plan data.

20. An interactive computer-implemented system as claimed in claim 18, whereby the web server is functionally linked with a database such that the user is enabled to store selected design and structural features to the database in a first session, and retrieve/modify such design and structural features from the database in a second session.

21. An interactive computer-implemented system as claimed in claim 19, whereby the home selection program enables the user to reset the selected design and structural features to a plurality of default design and structural feature settings.

22. An interactive computer-implemented system as claimed in claim 20, including the further step of requiring the user to submit location details of the proposed house, processing the location details, and providing objects corresponding to houses available for such location.

23. An interactive computer-implemented system as claimed in claim 21, whereby the home selection program enables selection of design and structural features including roofing materials, siding materials, interior wall coverings, ceiling details, door details, deck details, railing details and window details.

24. An interactive computer-implemented system as claimed in claim 22, whereby the home selection program enables selection of colours of selected home design details.

25. An interactive computer-implemented system as claimed in claim 23, including the further step of providing the user with a list of selected design and structural features, and requiring that the user verify each item on the checklist prior to processing the user's order.

26. A computer program product having a computer readable medium having computer readable code recorded thereon for:
providing access to one or more web pages including a plurality of objects corresponding with design and structural features of homes including floor plan data and design feature data;
providing the price associated with the plurality of objects;
enabling the selection of the design and structural features of a selected home through a web interface, including the selection of a modified floor plan by enabling the user to input modified floor plan data through the web interface;
calculating the price associated with the selected design and structural features, and providing the calculated price to the user; and
enabling the user to place an order for a selected home acceptable to the user.
